(19) United States
(12) Patent Application Publication
(10) Pub. No.: US 2026/0095691 A1
(43) Pub. Date: Apr. 2, 2026

(54) Perforated Compression Chamber With Acoustic Lensing Effect For AVAS Application

(71) Applicant: B&C SPEAKERS NA (USA), LLC, POMPTON PLAINS, NJ (US)

(72) Inventors: Valentina Cardinali, BAGNO A RIPOLI (Firenze) (IT); Andrea Casadei, BAGNO A RIPOLI (Firenze) (IT); Phillip Graham, Tucker, GA (US)

(21) Appl. No.: 19/302,168

(22) Filed: Aug. 18, 2025

Related U.S. Application Data
(60) Provisional application No. 63/684,805, filed on Aug. 19, 2024.

(51) Int. Cl. H04R 1/28; H04R 1/34; H04R 7/12

(52) U.S. Cl. CPC H04R 1/2811; H04R 1/345; H04R 7/127; H04R 2400/13; H04R 2499/13

(57) ABSTRACT

A compression chamber with two acoustic exit paths includes an inner bounding face formed by the outer surface of a vibrating diaphragm and an outer bounding face formed by a perforated occluding body positioned opposite the diaphragm. The perforated occluding body includes at least one opening extending through its thickness that forms a first acoustic exit path. A second acoustic exit path exists around the perimeter edge of the compression chamber. The acoustic energy from both exit paths combines to provide frequency-selective increase in sound pressure level and directional control over specific frequency ranges. The design enables a single electrodynamic transducer to function effectively for both broadband acoustic vehicle alerting system applications and high sound pressure level horn applications through control of acoustic impedance parameters including perforated occluding body thickness, perforation diameter, and total open area.

### CROSS REFERENCE TO RELATED APPLICATION

This U.S. Non-provisional patent application claims the benefit of and priority to U.S. Provisional Patent Application No. 63/684,805, titled Perforated Compression Chamber with Acoustic Lensing Effect for AVAS Application, and filed 19 Aug. 2024, which is incorporated in its entirety by reference herein.

### TECHNICAL FIELD

Embodiments relate to acoustic devices, specifically compression chambers for loudspeakers used in applications requiring both broadband acoustic output and frequency-selective sound pressure level enhancement. The compression chamber utilizes dual acoustic exit paths to achieve controlled acoustic impedance across different frequency ranges. More particularly, embodiments relate to acoustic devices suitable for Acoustic Vehicle Alerting System (AVAS) applications where both warning sounds and horn functionality are required from a single transducer assembly.

### BACKGROUND OF THE INVENTION

Acoustic Vehicle Alerting Systems (AVAS) have become mandatory in some jurisdictions for hybrid and electric vehicles to provide audible warnings to pedestrians. These systems require transducers capable of producing broadband sounds at moderate sound pressure levels. Separately, vehicles require horn functionality producing high sound pressure levels at specific frequencies for emergency signaling.

Traditional cone speakers can adequately produce the broadband sounds required for AVAS applications. However, these same speakers are inadequate to meet the sound pressure level requirements for vehicle horn applications at the required frequencies. The fundamental limitation arises from the acoustic impedance mismatch between the stiff speaker cone and the compliant ambient air. This mismatch prevents efficient acoustic power transfer, particularly at the frequencies where horn operation demands maximum output.

Prior art has addressed acoustic coupling challenges through various approaches. Horn-loaded transducers utilize expanding flares to achieve impedance transformation between the driver and free space. Resonant cavity designs employ Helmholtz resonators to enhance output at specific frequencies through stored acoustic energy. Some implementations combine these approaches with stacked horn and resonator configurations. While some devices attempt to cover both AVAS and horn operation, the most common configuration employs separate transducers systems for horn and AVAS functionality. This results in increased cost, space requirements, and complexity within the vehicle.

Various approaches to AVAS implementation have been disclosed in the prior art. U.S. Pat. No. 10,482,687 teaches diagnostic systems for AVAS using sensors and processors to detect system errors but does not address the acoustic performance limitations of the transducer itself. Japanese Patent No. 6806834 describes AVAS systems with multiple acoustic paths including ducts and communication paths between openings, representing a complex mechanical solution. Japanese Patent No. 5499911 discloses alarm devices with shielding plates creating specific directional openings at 180-degree orientations, focusing on directional control rather than improved acoustic impedance coupling.

Other prior art attempts have focused on specialized diaphragm configurations. Chinese Patent No. 113196801 teaches speakers with mechanically coupled conical and bending wave diaphragms driven by a single exciter, requiring complex mechanical linkages. PCT Application No. PCT/EP2022/056129 teaches specific volume ratios between protective grille spaces and the loudspeaker mounting cavity for SPL enhancement in narrow frequency bands.

The challenge in combining AVAS and horn functionality (H-AVAS) in a single device lies in the conflicting requirements. AVAS operation demands frequency response across a broad spectrum at moderate levels. Emergency alert (i.e. “horn”) operation requires maximum acoustic output at specific frequencies, typically achieved through acoustic resonance enhancement. Existing solutions require separate transducers for each function, increasing cost, weight, complexity, and installation time. Prior art has failed to provide a simple solution that enables dual-mode operation through control of the acoustic impedance in the area adjacent to the transducer.

### BRIEF SUMMARY

We present a novel acoustic device design that enables a single transducer to function effectively for both AVAS broadband operation and high sound pressure level horn operation. The design utilizes a perforated compression chamber that provides two distinct acoustic exit paths whose combined acoustic impedance characteristics create frequency-selective enhancement while maintaining broadband capability.

The compression chamber is bounded by a vibrating diaphragm of an electrodynamic transducer on one side and a perforated occluding body on the opposing side. The perforated occluding body provides a first acoustic exit path through its thickness via uniformly sized and shaped openings. A second acoustic exit path exists around the perimeter edge of the compression chamber. The two paths combine, forming an acoustic impedance that provides increased sound pressure level over a specific frequency range while maintaining suitable frequency response at a range of other frequencies.

The perforated occluding body parameters-including thickness, perforation diameter, and total open area-control both the resistive and reactive components of the acoustic impedance through the perforated occluding body. Combined with the perimeter path impedance, these parameters enable tuning of the frequency range experiencing enhanced output from the compression chamber. Additionally, the interaction of the two acoustic paths creates an acoustic lensing effect that provides directional control of the radiated sound over a portion of its bandwidth.

Unlike existing designs requiring complex internal geometries, multiple transducers, or multiple subsystems, this design achieves AVAS and horn functionality through control of acoustic impedance using simple geometric parameters that are readily manufacturable using conventional techniques.

### BRIEF DESCRIPTION OF THE DRAWINGS

For a more complete understanding of this disclosure, reference is now made to the following brief description, taken in connection with the accompanying drawings and detailed description, wherein like reference numerals represent like parts, in which:

FIG. 1A is an isometric view of an embodiment, showing the main external features of the compression chamber and sealed baffle enclosure;

FIG. 1B is an isometric view of an embodiment, showing the perforated occluding body that forms a portion of the compression chamber separated from the embodiment;

FIG. 2 is a cross-sectional view of the compression chamber assembly according to an embodiment of the invention, showing the diaphragm, perforated occluding body, dual acoustic exit paths, and arrangement of perforations according to an embodiment;

FIG. 3A is a simulation graph showing the real component of the acoustic impedance versus frequency comparing performance with and without the perforated compression chamber of an embodiment;

FIG. 3B is a measured graph showing sound pressure versus frequency comparing performance with the perforated compression chamber of multiple sample units of an embodiment;

FIG. 4 is a polar plot simulation showing the directivity pattern achieved through the acoustic lensing effect of the compression chamber;

FIG. 5 is an exploded view showing integration with a sealed baffle enclosure behind the electrodynamic transducer diaphragm;

FIG. 6A is a top down view of an alternative embodiment with non-uniform circular perforations that form the first acoustic path exits;

FIG. 6B is a dimetric view of an alternative embodiment with non-uniform circular perforations that form the first acoustic path exits;

FIG. 7A is a top down view of an alternative embodiment with uniform non-circular perforations that form the first acoustic path exits;

FIG. 7B is a dimetric view of an alternative embodiment with uniform non-circular perforations that form the first acoustic path exits;

FIG. 8A is a top down view of an alternative embodiment with perforations of mixed size and shape that form the first acoustic path exits;

FIG. 8B is a dimetric view of an alternative embodiment with perforations of mixed size and shape that form the first acoustic path exits;

FIG. 9A is a top down view of an alternative embodiment with adjustable perforation that occludes some of the first acoustic path exits;

FIG. 9B is a dimetric view of an alternative embodiment with adjustable perforation that occludes some of the first acoustic path exits;

FIG. 10A is a top down view of an alternative embodiment where the second acoustic exit, which is formed by the outer wall of the compression chamber, extends beyond the perimeter of the vibrating diaphragm;

FIG. 10B is a dimetric view of an alternative embodiment where the second acoustic exit, which is formed by the outer wall of the compression chamber, extends beyond the perimeter of the vibrating diaphragm;

FIG. 11A is a top down view of an alternative embodiment where a convex dome vibrating diaphragm forms one boundary of the compression chamber opposite the perforated occluding body;

FIG. 11B is a dimetric view of an alternative embodiment where a convex dome vibrating diaphragm forms one boundary of the compression chamber opposite the perforated occluding body.

### DETAILED DESCRIPTION

### Detailed Description

The following detailed description refers to the accompanying figures, in which like reference numerals indicate like elements throughout the several views. The embodiments described herein are provided by way of example only and are not intended to limit the scope of the invention.

A compression chamber assembly for a loudspeaker is shown in the various drawings. The assembly is designed to provide both broadband acoustic output and frequency-selective sound pressure level (SPL) enhancement, suitable for applications such as Acoustic Vehicle Alerting Systems (AVAS) and vehicle horn functionality.

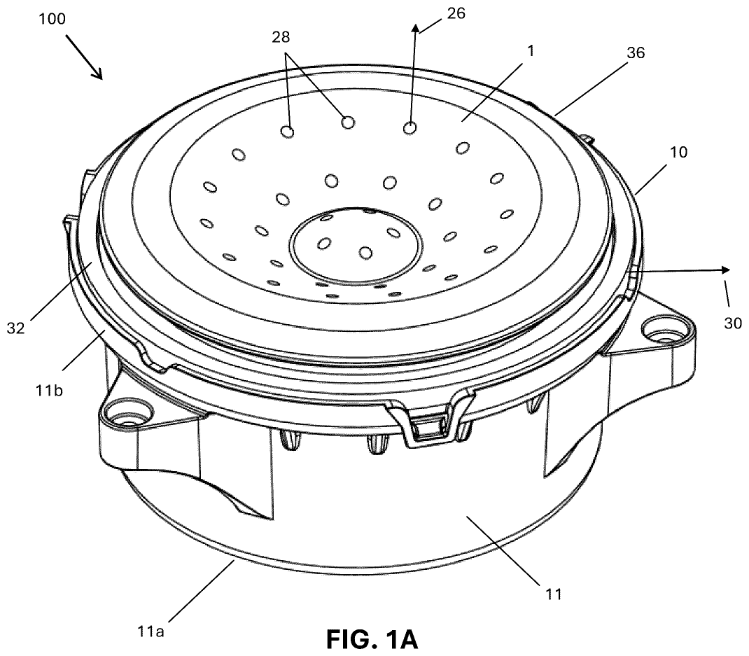

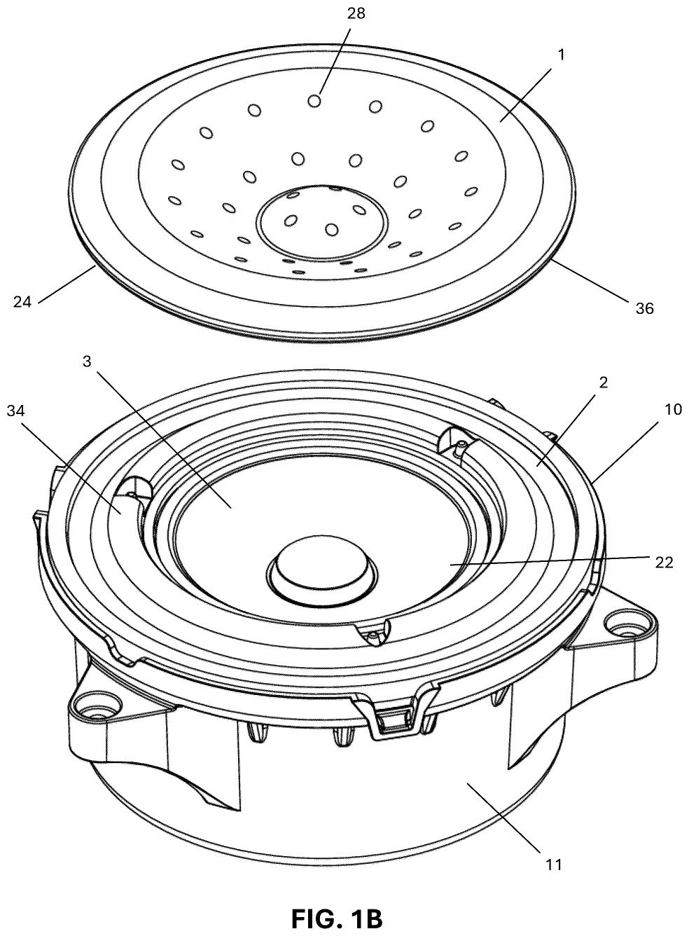

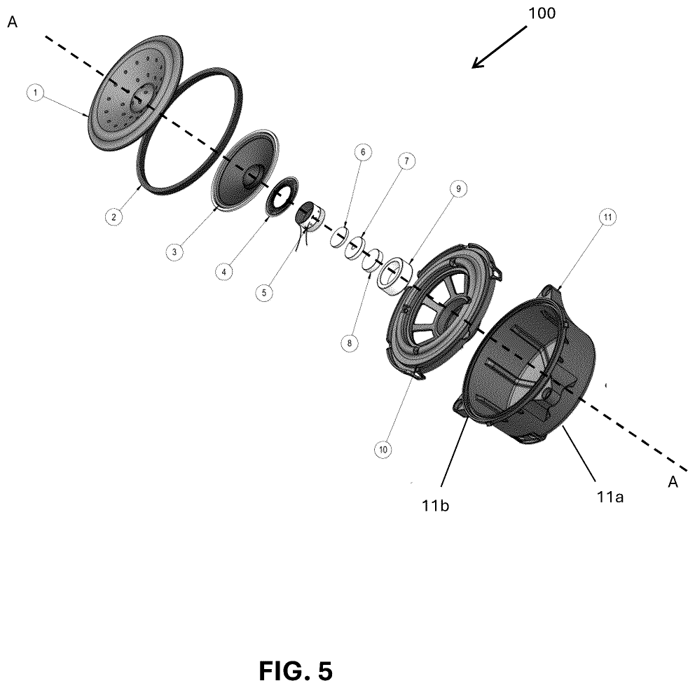

Referring particularly to FIGS. 1A, 1B, 2, and 5, an acoustic transducer 100 is shown as being formed of a cabinet 11 which, in the illustrated exemplary embodiment, is a generally cylindrical member having an outer wall which extends around a central axis A-A shared by the cabinet 11 and the acoustic transducer 100. The cabinet 11 further includes a substantially closed end 11a and an opposite open end 11b, both extending normal with respect to the central axis A-A. A basket 10 is disposed in the open end 11b of the cabinet 11. The basket 10 supports a suspension 4, a voice coil 5, a first magnet 6, a top plate 7, a second magnet 8, and a yoke 9. These elements 4-9 combine in a known manner to drive a diaphragm 3 which is disposed upon the basket 10 and in communication with such elements 4-9. The diaphragm 3 is circular and is arranged substantially symmetrically around the central axis A-A which is positioned at the center of the diaphragm and normal to an outer surface thereof. A gasket 2 is disposed around the diaphragm and used to seal the basket 10 and cabinet 11 from the outer environment. Finally, a perforated occluding body 1 is disposed over the diaphragm 3.

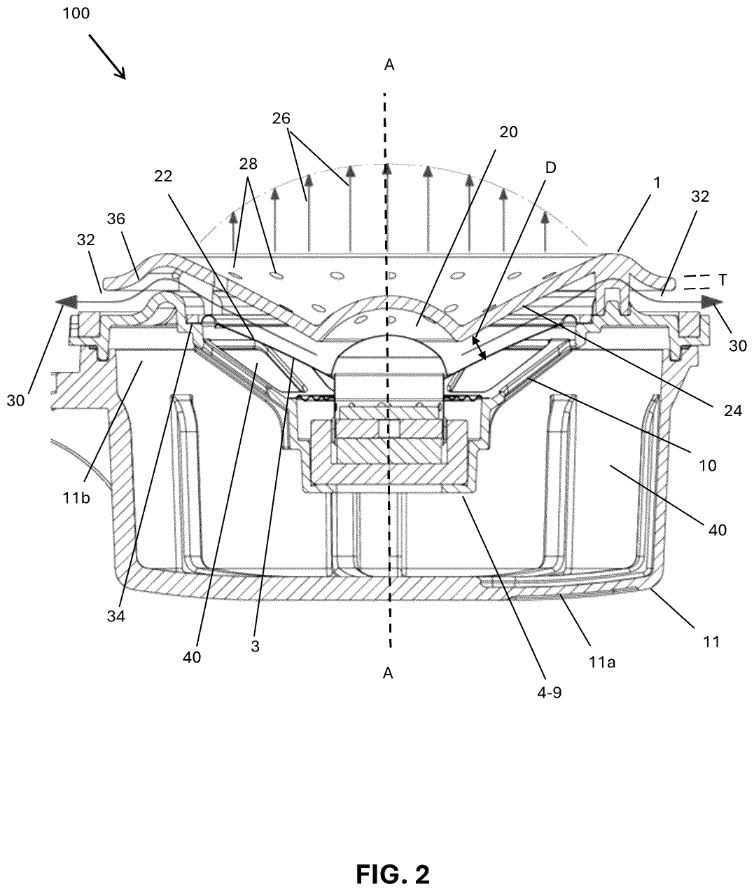

FIG. 2 shows a cross-sectional view of the acoustic transducer 100 and particularly illustrates a compression chamber 20 delimited within the transducer 100. The compression chamber 20 is defined by an inner bounding face 22, formed by the outer surface of the diaphragm 3, and by an outer bounding face 24, which is formed by an inner surface of the perforated occluding body 1. The perforated occluding body 1, in one exemplary embodiment, is of substantially uniform thickness T and is spaced at a substantially uniform distance D from the diaphragm 3. The thickness T of the perforated occluding body 1 is chosen to optimize acoustic output and performance. For example, the thickness may be in the range of about 1 mm to about 10 mm.

The invention provides at least two distinct acoustic exit paths for sound energy generated by the diaphragm 3.

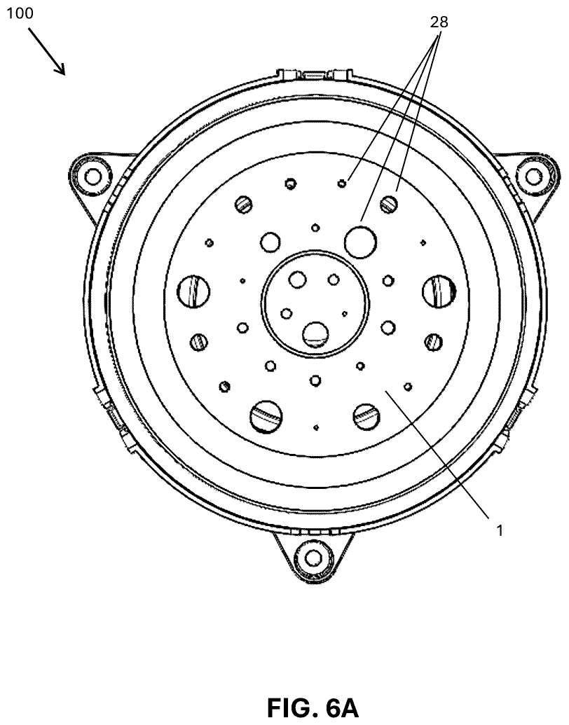

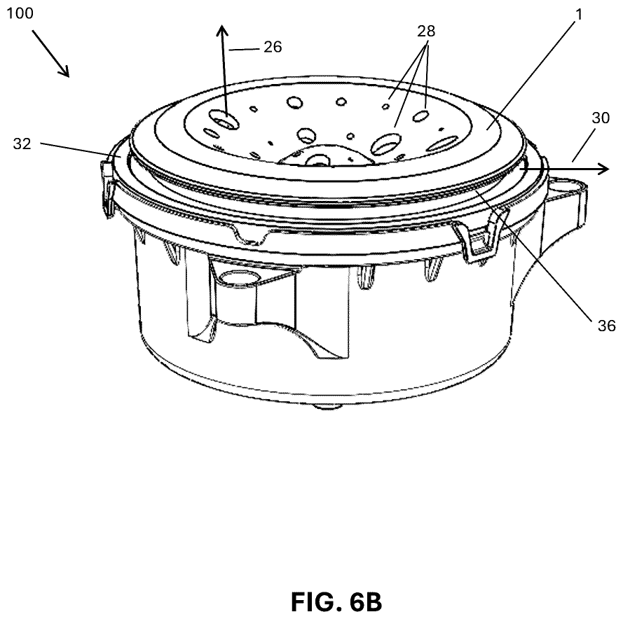

A first acoustic exit path 26 is formed by at least one opening 28 extending fully through the thickness T of the perforated occluding body 1. The first acoustic exit path 26 allows part of the acoustic energy produced by the diaphragm 3 within the compression chamber 20 to pass through the openings 28 to an exterior of the acoustic transducer 100, propagating in a direction generally parallel to the axis A-A. The openings 28 forming the first acoustic exit path 26 may be uniform circular perforations, non-uniform circular perforations, uniform non-circular perforations, or a mixture of sizes and shapes, as illustrated, for example, in FIGS. 6A-8B. The total open area, the size, and the shape of the openings 28 are selected to control the resistive and reactive components of the acoustic impedance of the first acoustic exit path 26. For example, the total open area provided by the openings 28 may be about 1% to about 30% of the total surface area of the perforated occluding body 1. Where the openings are circular, they may include a diameter of about 1 mm to about 10 mm. In one preferred embodiment, with uniform circular openings, the thickness T of the perforated occluding body is about 3 mm thick, and the openings 28 have a diameter of about 3.1 mm, and the total area of the openings is about 3.2% of the surface area of the perforated occluding body 1.

As illustrated in FIGS. 1A-1B, the openings 28 in the perforated occluding body 1 may comprise uniform perforations of circular shape, each having the same diameter. There may be a single circular opening 28, or as illustrated, a plurality of circular openings 28, for example, thirty uniform circular openings 28.

However, in other embodiments, the openings 28 in the perforated occluding body 1 may comprise non-uniform perforations. For example, FIGS. 6A and 6B illustrate embodiments where the openings 28 are non-uniform circular perforations, allowing for tailored impedance characteristics. That is, the openings 28 of FIGS. 6A-6B have circular shapes of differing diameter.

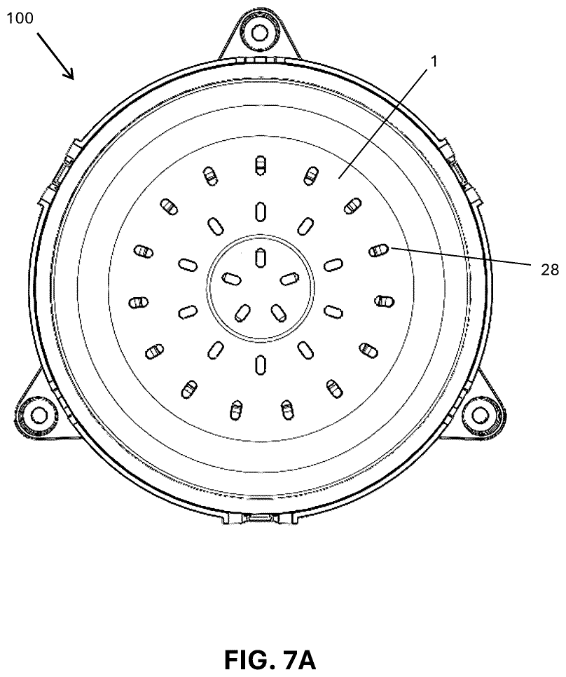

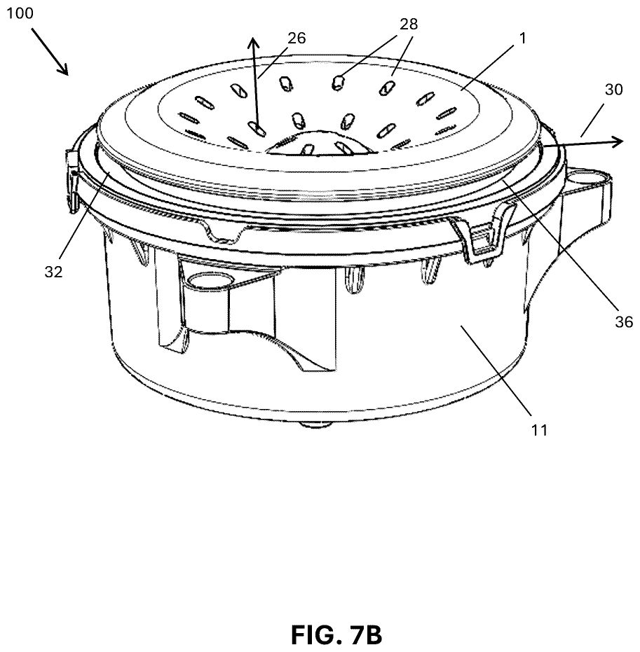

In still further embodiments, the openings 28 in the perforated occluding body 1 may comprise uniform non-circular perforations. For example, FIGS. 7A and 7B show the openings 28 uniformly shaped and sized as non-circular perforations (e.g., slots or ellipses). Non-circular perforations can be oriented in specific directions to influence the directional characteristics of the radiated sound. For instance, elongated slots aligned radially or tangentially can be used to shape the polar response of the loudspeaker, enhancing directivity, to tailor the frequency response as needed for the application.

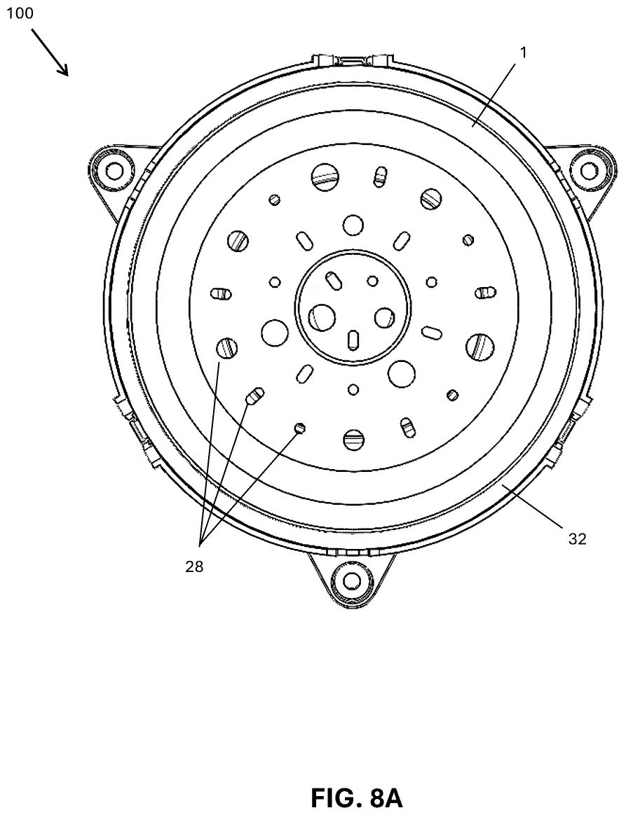

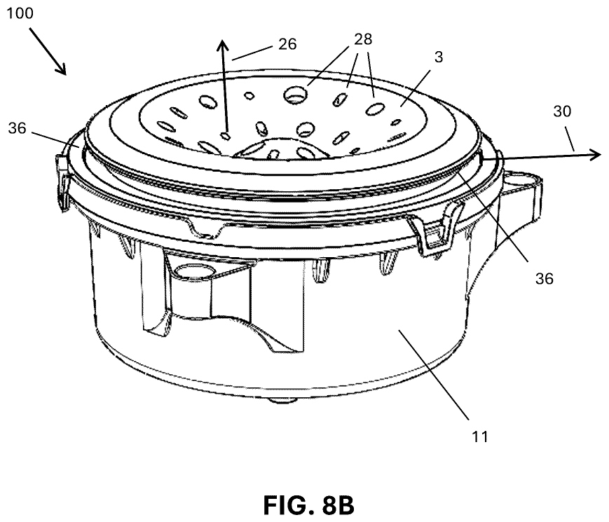

In another embodiment, the openings 28 in the perforated occluding body 1 may comprise perforations having mixed shapes. For example, FIGS. 8A and 8B depict the openings 28 having a mixture of perforation sizes and shapes to enable tuning of the complex acoustic impedance. In the illustrated embodiment, the openings 28 comprise a mix of circular openings 28 having various diameters and ellipse-shaped openings 28 having common lengths and widths. In other embodiments, the lengths and widths of the ellipse-shaped openings 28 may vary as needed to achieve a desired acoustic result. This approach enables complex acoustic impedance profiles, allowing the designer to combine the benefits of both non-uniform and non-circular perforations. The total open area, as well as the distribution and geometry of the openings 28, can be optimized to achieve a desired balance between broadband output and frequency-selective enhancement. This embodiment is useful for applications requiring support of both AVAS and horn functionality with separate acoustic signatures.

The openings 28 may comprise any other geometric shape, for example, triangle, square, rectangle, parallelogram, rhombus, trapezoid, pentagon, hexagon, heptagon, octagon, nonagon, or any regular or irregular polygon, or any non-geometric abstract shape. Various shapes and sizes may be intermixed, or they may be used in uniform manner in terms of size and/or shape. The spatial distribution of the openings 28 may be uniform and regular, or varied, or a combination of both.

By strategically varying the size and placement of the openings 28, the designer can target specific frequency ranges for enhancement or attenuation, providing a tailored response for unique AVAS or horn requirements. For example, larger perforations may be positioned near the center of the perforated occluding body to favor low-frequency transmission, while smaller perforations near a periphery can help shape high-frequency output.

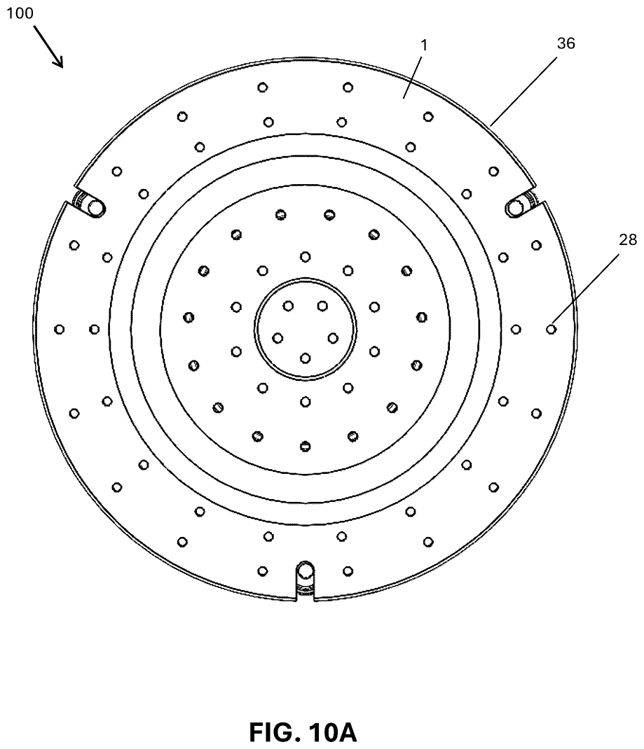

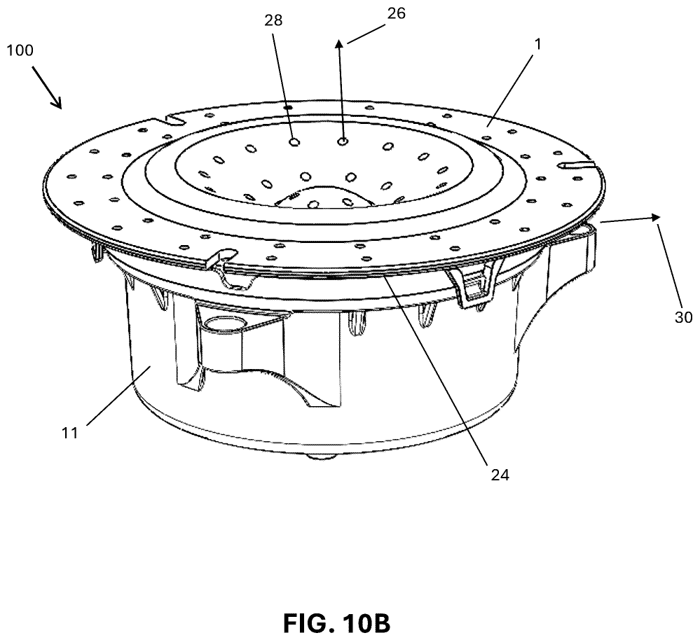

The compression chamber 20 includes a perimeter edge 32 formed by a first peripheral edge 34 of the inner bounding face 22 and a second peripheral edge 36 of the outer bounding face 24. See, e.g., FIG. 2. The perimeter edge 32 extends around an outer periphery of the compression chamber 20 and around an outer periphery of the acoustic transducer 100. A second acoustic exit path 30 extends from the compression chamber 20, through the perimeter edge 32, to the exterior of the transducer 100. That is, acoustic energy produced by the diaphragm 3 may propagate radially relative to the axis A-A, along the second acoustic exit path 30 through the perimeter edge 32 to the exterior of the transducer 100, in a direction generally normal to the axis A-A. As illustrated in FIG. 2, the first and second peripheral edges 34, 36 are disposed proximate to one another and are aligned along an axis parallel to the axis A-A. However, in other embodiments, as shown in FIGS. 10A and 10B, the second peripheral edge 36 of the outer bounding face 24 extends beyond a maximum diameter of the diaphragm 3, and hence beyond the first peripheral edge 34 of the inner bounding face 22. That is, in this variation, the first and second peripheral edges 34, 36 are not aligned along an axis parallel to the axis A-A. This configuration increases the effective area of the second acoustic exit path 30, which can be used to further control the acoustic impedance and directivity of the radiated sound. By extending the perimeter, the designer can control the frequency range where the embodiment exhibits the most directional control over its polar radiation behavior and lower the center frequency of where the sound is boosted for the horn function by the perforated occluding body.

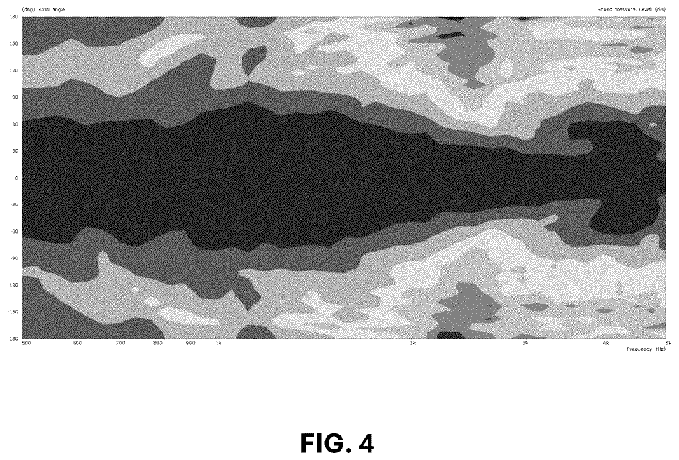

The combined acoustic impedance of the first and second acoustic exit paths 26, 30 is a function of the geometric parameters of the perforated occluding body 1, including its thickness T, the diameter and shape of the openings 28, and the total open area. By adjusting these parameters, the frequency range over which sound pressure level is enhanced can be precisely tuned. The interaction of the two acoustic exit paths 26, 30 also creates an acoustic lensing effect, providing directional control of the radiated sound along the central axis A-A, as demonstrated in the polar plot of FIG. 4. There, a polar plot simulation illustrates normalized output vs. radiation angle of an idealized compression chamber 20.

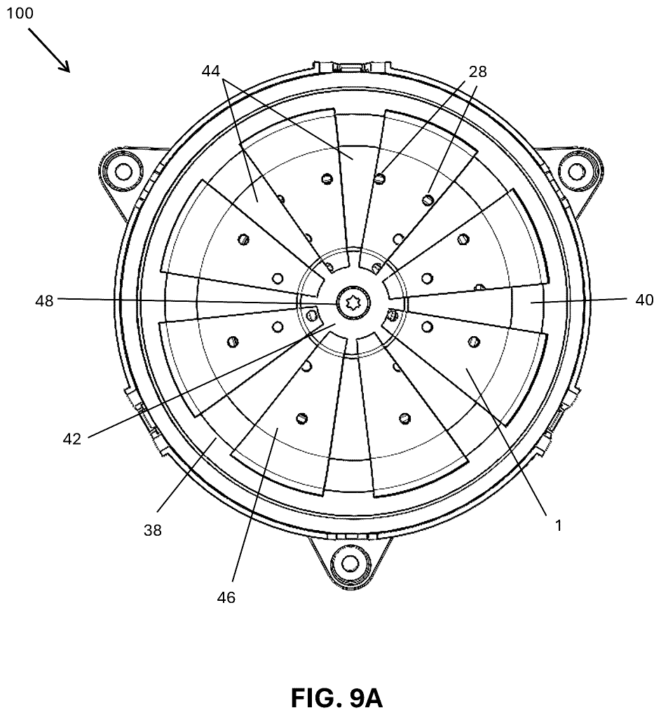

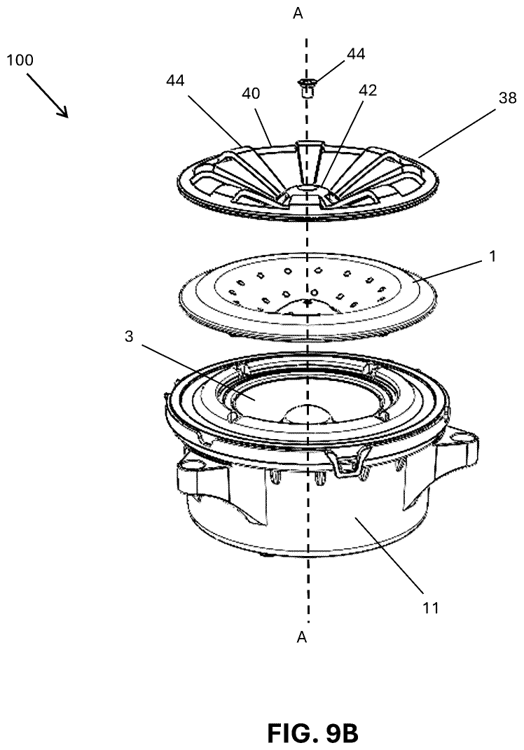

As discussed thus far, the total open area of the first acoustic exit path 26 is fixed and is determined by the size and number of openings 28. However, in alternate embodiments, the total open area of the first acoustic exit path 26 is adjustable. For example, as shown in FIGS. 9A and 9B, one or more louvers 38, or similar occluding elements, may be positioned to selectively block portions of the openings 28, allowing real-time adjustment of the acoustic impedance and output characteristics. In the illustrated embodiment, the louver 38 includes a perimeter member 40 extending around an outer circumference thereof with a central hub portion 42 disposed centrally relative to the axis A-A. A plurality of radial members 44 extend from the central hub 42 to the perimeter member 40 in a direction generally normal to the axis A-A. The perimeter member 40, the central hub 42, and the radial members 44 delimit open areas 46. The louver 38 may be fixed rotatably to the transducer 100 by a fixing element 48.

Accordingly, the louver 38 is rotatable about the central axis A-A in such a manner that the radial members 44 may be moved into an occluding position where they block certain openings 28, while other openings 28 are aligned with the open areas 46 and are not occluded. This feature enables dynamic switching between AVAS and horn modes or adaptation to changing frequency requirements for horn operation in different operational contexts.

A similar louver may be used to regulate the total area of the second acoustic exit path 30. That is, a louver having a similar structure with one or more perimeter members may support a plurality of occluding members, thus delimiting open spaces. Such louver may be an extension of the above-described louver 38 and be rotatably maneuverable therewith, or may be a separate elements disposed fixedly or moveably upon the transducer 100. This louver extends over the second acoustic exit path 30 and occludes certain portions thereof to selective reduce the total area of the path 30. Such louver may be used independently or in combination with the above described louver 38.

These various louvers described herein can be mechanically or electronically actuated to selectively block or open portions of the openings 28 in the perforated occluding body 1. This adjustability allows the compression chamber assembly 20 to switch between different operational modes, such as a broadband AVAS mode and a high-output horn mode, or to adapt to changing environmental or regulatory requirements. The ability to dynamically tune the total open area of the first acoustic exit path 26 and/or the second acoustic exit path 30 provides significant flexibility and utility.

In some embodiments, the diaphragm 3 may also form a partial boundary of an air-filled mechanical enclosure 50, such as a sealed baffle, located behind the diaphragm 3, as shown in one embodiment in FIG. 2. This enclosure 50 provides an acoustical impedance load on the diaphragm 3 opposite the compression chamber 20, which can be tuned to optimize the overall frequency response and efficiency of the system. The sealed baffle enclosure 50 may be implemented in various shapes and volumes to suit the installation constraints and acoustic requirements of the vehicle or other end-use environment.

As generally illustrated in FIGS. 1, 2, and 5-10, the diaphragm 3 is concave or cone shape. That is, a central region of the diaphragm 3 is disposed more proximate to the closed end of the cabinet 11, while the outer edge of the diaphragm is proximate to the open end of the cabinet 11. In this manner, an outer region of the diaphragm 3 extends at an upward angle relative to the axis A-A, as illustrated in FIG. 2. As such, the concave diaphragm 3 has a generally batwing shape when viewed in cross-section, as in FIG. 2.

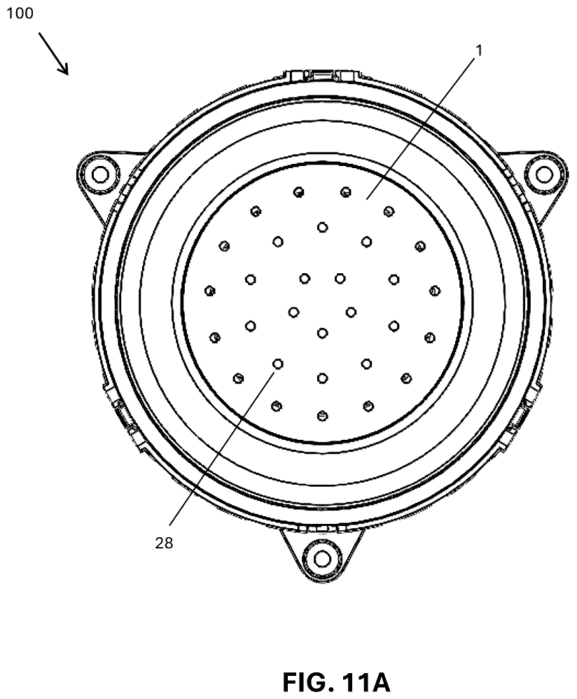

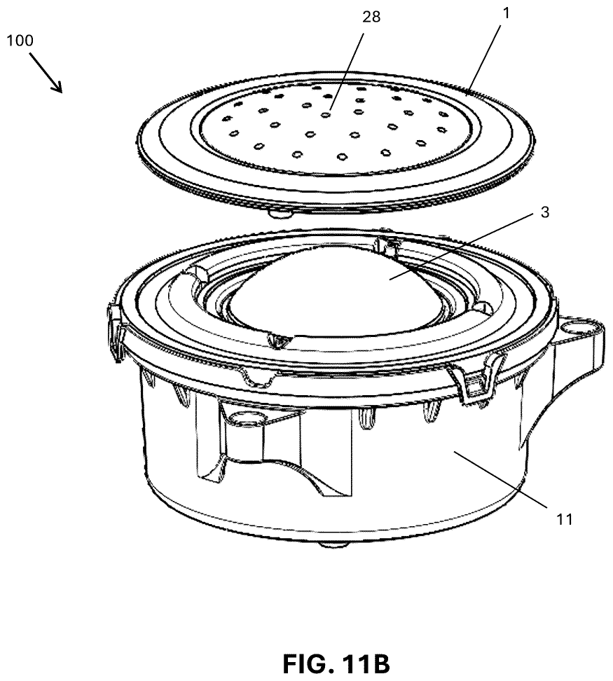

In alternative embodiments, the diaphragm 3 may be convex or dome shaped, as shown by way of example in FIGS. 11A and 11B. Here, a central region of the convex diaphragm 3 extends upwardly along the axis A-A toward the perforated occluding body 1, while the outer region of the convex diaphragm 3 extends in the opposite direction along axis A-A.

The use of a convex or concave diaphragm 3 alters the modal behavior and radiation pattern of the loudspeaker, which can be leveraged to achieve specific acoustic goals. Control of diaphragm curvature has interplay in amount of available radiation area, modal behavior, and performance of the electromotive assembly driving the diaphragm. The compression chamber 20 accommodates both diaphragm geometries, further increasing the versatility of the design.

These various alternative embodiments described herein demonstrate the adaptability of the compression chamber assembly 20 to a wide range of acoustic requirements. By varying the geometry and arrangement of the perforated occluding body 1, the configuration of the acoustic exit paths 26, 30, the shape of the diaphragm, and the use of adjustable louvers 38 or sealed enclosures 50, the invention can be tailored for optimal performance in both AVAS and horn applications, as well as other demanding acoustic environments such as emergency signaling.

In use, the electrodynamic acoustic transducer 100 drives the diaphragm 3, causing it to vibrate and generate acoustic energy. This energy is radiated into the compression chamber 20, where it exits the transducer 100 via both the first acoustic exit path 26, through the perforated occluding body 1, and via the second acoustic exit path 30 at the perimeter edge 32 of the chamber 20. The combined effect of these paths 26, 30 results in increased SPL over a specific frequency range and provides directional control of the radiated sound, as required for both AVAS and horn applications. For example, SPL may increase from about 1 kHz to about 3 kHz; directional control may increase from about 1.5 kHz to about 3.5 kHz.

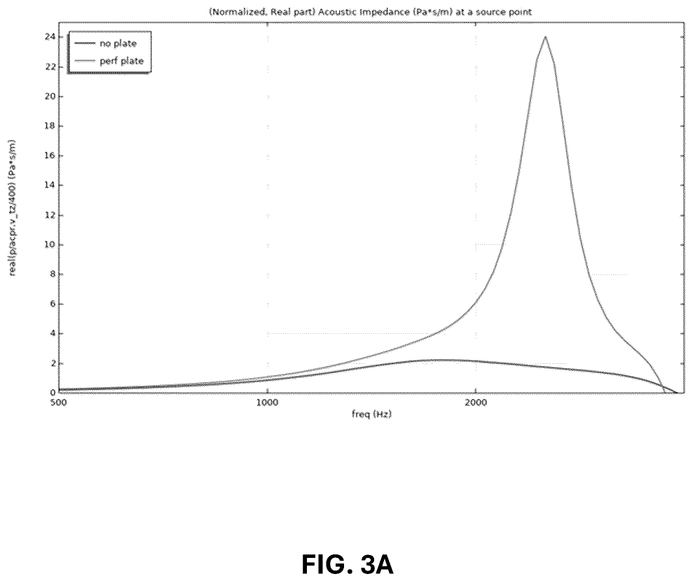

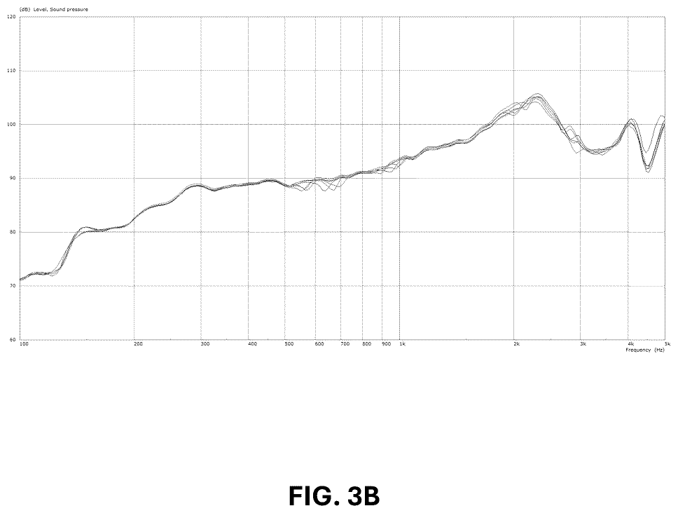

FIG. 3A illustrates the effect on acoustic impedance of the invention. The lower curve, shown in blue, illustrates the impedance of a traditional loudspeaker transducer without the perforated occluding body described herein. The higher curve, shown in green, illustrates the impedance of the transducer 100 with the perforated occluding body 1. This configuration minimizes the impedance mismatch between the relatively stiff diaphragm 3 and the compliant air in the compression chamber 20. That is, increasing the real (i.e. resistive) component of the acoustic impedance near the diaphragm 3 improves acoustic coupling in the frequency range above 2 kHz illustrated in FIG. 3A. Increased coupling means that more of the electrical energy sent to the transducer advantageously emerges as acoustic output.

FIG. 3B shows the measured SPL vs. frequency of six samples of an embodiment of the loudspeaker acoustic transducers with perforated occluding body, as described herein. As can be seen, SPL is advantageously enhanced with a peak in a frequency range of 1000-3000 Hz.

As described and illustrated herein, the invention provides a novel acoustic transducer with at least two acoustic exit paths, where at least one exit path may be tuned to effect and control the resistive and reactive components of the acoustic impedance of the compression chamber. Specifically, the thickness of the perforated occluding body, perforation diameter, and total open area provided by the perforated occluding body may be tailored to control these impedance components and provided enhanced acoustic output and directivity control.

Various embodiments of the present invention are described herein with reference to the related drawings. Alternative embodiments can be devised without departing from the scope of this invention. It is noted that various connections and positional relationships (e.g., over, below, adjacent, etc.) are set forth between elements in the description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship.

The term “exemplary” is used herein to mean “serving as an example, instance, or illustration.” Any embodiment or design described herein as “exemplary” is not necessarily to be construed as preferred or advantageous over other embodiments or designs. The terms “at least one” and “one or more” are understood to include any integer number greater than or equal to one, i.e., one, two, three, four, etc. The term “a plurality” is understood to include any integer number greater than or equal to two, i.e., two, three, four, five, etc. Terms such as “connected to”, “affixed to”, etc., can include both an indirect “connection” and a direct “connection.”

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A compression chamber for a loudspeaker, comprising:
a. an inner bounding face formed by an outer surface of a diaphragm wherein the diaphragm is configured to vibrate and produce an acoustic radiation when driven and wherein the diaphragm is arranged substantially symmetrical around a central axis positioned at the center of the diaphragm, and normal to the outer diaphragm surface;
b. an outer bounding face positioned opposite the diaphragm, and offset therefrom wherein the outer bounding face is formed by an inner surface of an occluding body having a substantially uniform thickness, and wherein the occluding body at least partially occludes the acoustic radiation of the diaphragm;
c. a first acoustic exit path formed by at least one opening extending fully through the thickness of the occluding body, wherein the at least one opening acoustically connects the inner surface to an outer surface of the occluding body; and
d. a second acoustic exit path at a perimeter edge of the compression chamber, formed by a peripheral edge of the inner bounding surface and a peripheral edge of the oppositely positioned outer bounding surface;
e. wherein acoustic energy from the first and second acoustic exit paths combines to provide increased sound pressure level over a specific frequency range, and directional control of radiated sound along the central axis over a specific frequency range.

2. The compression chamber of claim 1, wherein the outer bounding face of the compression chamber is spaced at a substantially uniform distance from the inner bounding face of the compression chamber.

3. The compression chamber of claim 1, wherein the second acoustic exit is axisymmetric about the central axis.

4. The compression chamber of claim 1, wherein the thickness of the occluding body is selected to control at least one of a resistive component and a reactive component of an acoustic impedance of the first acoustic exit path.

5. The compression chamber of claim 1, wherein the at least one opening comprises uniform circular perforations having a diameter selected to control at least one of a resistive component and a reactive component of an acoustic impedance of the first acoustic exit path.

6. The compression chamber of claim 1, wherein the at least one opening comprises non-uniform circular perforations, wherein a total open area of the non-uniform circular perforations controls at least one of a resistive component and a reactive component of an acoustic impedance of the first acoustic exit path.

7. The compression chamber of claim 1, wherein the at least one opening comprises uniform non-circular perforations having dimensions selected to control at least one of a resistive component and a reactive component of an acoustic impedance of the first acoustic exit path.

8. The compression chamber of claim 1, wherein the at least one opening comprises non-uniform non-circular perforations, wherein a total open area of the non-uniform non-circular perforations controls at least one of a resistive component and a reactive component of an acoustic impedance of the first acoustic exit path.

9. The compression chamber of claim 1, wherein the at least one opening comprises perforations of mixed size, shape, and spatial distribution, wherein at least one size distribution of the mixed size, shape, and spatial distribution of perforations controls at least one of a resistive component and a reactive component of an acoustic impedance of the first acoustic exit path.

10. The compression chamber of claim 1, wherein a total open area of the at least one opening of the first acoustic path is adjustable by one or more louvers positioned to selectively occlude portions of the at least one opening.

11. The compression chamber of claim 1, wherein the perimeter of the second acoustic exit, formed by the outer wall of the compression chamber, extends beyond a maximum diameter of the diaphragm.

12. The compression chamber of claim 1, wherein the diaphragm comprises a concave or convex surface of an electrodynamic transducer comprising one of a cone loudspeaker or a dome loudspeakers.

13. The compression chamber of claim 1, wherein the inner surface of the vibrating diaphragm forms a partial boundary of an air-filled mechanical enclosure that provides an acoustical impedance load on the diaphragm opposite the compression chamber.

14. The compression chamber of claim 1, wherein the openings of the occluding body comprises a plurality of concentric rings of said openings, each ring having openings of different diameter.

15. The compression chamber of claim 1, wherein the openings of the occluding body comprise a plurality of elongated slots oriented radially with respect to the central axis.

16. The compression chamber of claim 1, wherein the openings of the occluding body comprise a plurality of elongated slots oriented tangentially with respect to the central axis.

17. The compression chamber of claim 1, wherein the openings of the occluding body comprise a mixture of geometric shapes comprising circles, ellipses, triangles, squares, rectangles, and polygons.

18. The compression chamber of claim 1, further comprising a louver configured to selectively occlude portions of the at least one opening of the perforated occluding body.

19. The compression chamber of claim 18 wherein the louver is electronically or mechanically actuated in response to a control signal.

20. The compression chamber of claim 1, wherein the diaphragm delimits a sealed baffle enclosure comprising a volume selected to optimize the acoustic impedance load for a predetermined frequency range.

21. The compression chamber of claim 18, wherein the second acoustic exit path comprises a louver configured to selectively occlude portions of the perimeter edge.

22. The compression chamber of claim 1, wherein the occluding body comprises a plurality of micro-openings having diameters less than 1 mm.

23. A loudspeaker comprising the compression chamber of claim 1.
